(19) United States
(12) Patent Application Publication
(10) Pub. No.: US 2021/0155022 A1
(43) Pub. Date: May 27, 2021

(54) THERMAL TRANSFER PRINTER

(71) Applicant: BV Korthofah, Katwijk (NL)

(72) Inventors: Mark HAGEMAN, Katwijk (NL); Chris ST. JOHN CORDINGLEY, Katwijk (NL)

(73) Assignee: BV Korthofah, Katwijk (NL)

(21) Appl. No.: 16/628,044

(22) PCT Filed: May 28, 2018
(86) PCT No.: PCT/NL2018/050346

§ 371 Date: Jan. 2, 2020

(30) Foreign Application Priority Data
Jul. 3, 2017 (NL) 2019160

(51) Int. Cl. B41J 33/34; B41J 2/325; B41J 25/312

(52) U.S. Cl. CPC B41J 33/34; B41J 25/312; B41J 2/325

(57) ABSTRACT

Thermal transfer printer for selectively transferring a meltable ink material carried on a tape to a substrate intended to receive ink from said tape for printing an image on the substrate, the printer comprising a supply spool for the tape, a take-up spool for the tape, and a printhead between the supply spool and the take-up spool, wherein the supply spool is driven by a supply motor and the take-up spool is driven by a take-up motor, and that the printer comprises a spool drive controller which is configured to energize the supply motor and the take-up motor so as to arrange that the tape is un-wound from the supply spool and wound onto the take-up spool, wherein the spool drive controller is embodied with field oriented control driving the supply motor and the take-up motor so as to continuously and uninterruptedly control motor torque of said motor's.

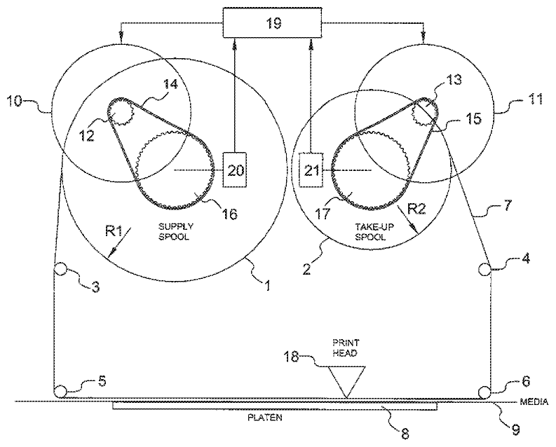

The invention relates to a thermal transfer printer for selectively transferring a meltable ink material carried on a tape to a substrate intended to receive ink from said tape for printing an image on the substrate, the printer comprising a supply spool for the tape, a take-up spool for the tape, and a printhead between the supply spool and the take-up spool, wherein the supply spool is driven by a supply motor and the take-up spool is driven by a take-up motor, and wherein the printer comprises a spool drive controller which is configured to energize the supply motor and the take-up motor so as to arrange that the tape is un-wound from the supply spool and wound onto the take-up spool.

Such a thermal transfer printer is known from U.S. Pat. No. 8,221,010, and employs stepper motors for driving the supply spool and take-up spool.

A disadvantage of using stepper motors in the manner as proposed by U.S. Pat. No. 8,221,010 is that positional resolution is limited by the step size of the motors, and that the tape is subjected to tension spikes each time the motors are energized.

It is an object of the invention to provide a thermal transfer printer with smooth tension control in the tape, as well as a high positional resolution. Also speed control of the tape should be of the highest standard.

According to the invention the thermal transfer printer is provided with the features of at least one of the appended claims.

In a first aspect of the invention the spool drive controller is embodied with field oriented control driving the supply motor and the take-up motor so as to continuously and uninterruptedly control motor torque of said motors, wherein the supply spool is provided with a supply encoder and the take-up spool is provided with a take-up encoder, which encoders provide positional information, and said encoders being connected to the spool drive controller so as to arrange that the spool drive controller controls the tape's tension, position and speed. Accordingly the loss of positional accuracy caused by skipped steps present in prior art stepper drive methods is avoided. Positional inaccuracy as present in the prior art leads to a number of problems including bad prints and potentially snapped tape. The term ‘motor’ is unspecified which means it can be any type of motor, albeit that there is a restriction in that the motor should be of the electric type such as for instance a permanent-magnet synchronous ac motor or a multi-coil synchronous motor. Field oriented control as such is known to the skilled person and requires no further elucidation. Suffice it to say that in “Field Oriented Control” the multiple motor input currents are adjusted independently to set a specific magnitude and a specific angle between a stator magnetic field and a rotor magnetic field. Motor torque varies in proportion to the sine of this angle between stator and rotor fields, as well as their magnitudes. By continuously sensing the rotor position, the stator coil currents can be continuously adjusted to produce the required torque, whilst accounting for the continuous changes in the position of the rotor magnetic field as it moves (rotates).

As mentioned smooth ‘jerk-free’ movement of the tape is important to stop the tape from breaking or snagging. By varying motor coil currents in a sinusoidal manner, there are no sudden changes, and jerky movements are completely avoided. Problems of mechanical resonance are also reduced with this technique as the periodic stimulation caused in the prior art by pulsed operation of the stepper motors, is absent.

It is remarked that U52016/0342125 teaches the application of vector control—also known as field oriented control—in a motor control apparatus of an image forming apparatus, i.e. a printer. Such a printer is a standalone apparatus for use in an office or home environment for printing text or images on a sheet of paper. This is distant from the thermal transfer printer of the invention which is designed and intended for selectively transferring a meltable ink material carried on a tape to a substrate intended to receive the ink from said tape for printing an image on the substrate. The thermal transfer printer of the invention is not suited for use in an office or home environment, but is used in an industrial setting, wherein it is integrated in a packaging or assembly line to print product and traceability information like expiration dates and bar codes on packaging material like LDPE film. A skilled person looking for improvement of the thermal transfer printer of U.S. Pat. No. 8,221,010, would therefore not be incited to consult the teaching of US2016/0342125.

It is further preferred that the printhead is driven by a motor for driving the printhead down to produce a force by pressing the substrate down onto a counter pressure platen, wherein the motor is energized with field oriented control.

The invention will hereinafter be further elucidated with reference to the drawing of an exemplary embodiment of an apparatus according to the invention that is not limiting as to the appended claims.

In the drawing:

the FIGURE shows an apparatus according to the invention.

The single FIGURE shows schematically and functionally some components of a thermal transfer printer according to the invention, notably a supply spool 1 with tape to be unwound and to be wound up onto a take-up spool 2. In transferring from the supply spool 1 to the take-up spool 2 the tape 7 passes a printhead 18 which when energized causes ink to be transferred from the tape 7 to a substrate 9. A platen 8 provides counter pressure to the substrate 9 during activation of the printhead 18. The functionality of the supply spool 1 and the take-up spool 2 can also be reversed.

The tape 7 is guided from the supply spool 1 to the take-up spool 2 along guides 3, 4, 5, 6.

Rotation of the supply spool 1 and the take-up spool 2 is caused by a supply motor 10 and a take-up motor 11 that drive the supply spool 1 and take-up spool 2 either directly or through a system of belts 14, 15 and toothed wheels 12, 13 and 16, 17 or gears.

The supply motor 10 and the take-up motor 11 are controlled by a spool drive controller 19 which takes account of the amount of tape 7 being present on the supply spool 1 and the take-up spool 2. Preferably for this purpose the supply spool 1 and the take-up spool 2 are provided with position encoders 20, 21 that provide the spool drive controller 19 with positional information. Said encoders 20, 21 are connected to the spool drive controller 19 so as to arrange that the spool drive controller 19 controls the tape's tension, position and speed, wherein the spool drive controller 19 is embodied with field oriented control so as to drive the supply motor 10 and the take-up motor 11 to continuously and uninterruptedly control the motor torque of said motors 10, 11.

According to another aspect of the invention the printhead 18 is driven by a motor (not shown) for driving the printhead 18 down to produce a force by pressing the substrate 9 down onto the counter pressure platen 8, wherein the motor for the printhead 18 is energized with field oriented control.

Although the invention has been discussed in the foregoing with reference to an exemplary embodiment of the apparatus of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

1. Thermal transfer printer for selectively transferring a meltable ink material carried on a tape (7) to a substrate intended to receive ink from said tape (7) for printing an image on the substrate (9), the printer comprising a supply spool (1) for the tape (7), a take-up spool (2) for the tape (7), and a printhead (18) between the supply spool (1) and the take-up spool (2), wherein the supply spool (1) is driven by a supply motor (10) and the take-up spool (2) is driven by a take-up motor (11), and wherein the printer comprises a spool drive controller (19) which is configured to energize the supply motor (10) and the take-up motor (11) so as to arrange that the tape (7) is unwound from the supply spool (1) and wound onto the take-up spool (2), characterized in that the spool drive controller (19) is embodied with field oriented control driving the supply motor (10) and the take-up motor (11) so as to continuously and uninterruptedly control motor torque of said motors.

2. Thermal transfer printer according to claim 1, characterized in that the supply spool (1) is provided with a supply encoder (20) and the take-up spool (2) is provided with a take-up encoder (21), which encoders (20, 21) provide positional information, and said encoders (20, 21) being connected to the spool drive controller (19) so as to arrange that the spool drive controller (19) controls the tape's tension, position and speed.

3. Thermal transfer printer according to claim 1 or 2, characterized in that the printhead (18) is driven by a motor for driving the printhead (18) down to produce a force by pressing the substrate (9) down onto a counter pressure platen (8), wherein the motor is energized with field oriented control.
